(19) United States
(12) Patent Application Publication
(10) Pub. No.: US 2016/0375942 A1
(43) Pub. Date: Dec. 29, 2016

(54) TRAILER MOVER

(71) Applicant: Ted Chen, Hacienda Heights, CA (US)

(72) Inventor: Ted Chen, Hacienda Heights, CA (US)

(21) Appl. No.: 14/752,627

(22) Filed: Jun. 26, 2015

(51) Int. Cl. B62D 49/00; B60D 1/24; B60D 1/06

(52) U.S. Cl. CPC B62D 49/007; B60D 1/065; B60D 1/245; B60D 2001/008

(57) ABSTRACT

A trailer mover has a ball connection mechanism having a ball head mounted on a ball post and a ball collar. The ball collar has a raised position and a lowered position. The ball collar is mounted to the ball post so that the ball collar moves relative to the ball post when the ball collar is traveling between the raised position and the lowered position. The housing comprises a carriage body having a ball post retainer mounting surface on an upper portion of the carriage body. A ball post retainer is mounted to the ball post retainer mounting surface. The ball post retainer is configured to receive the ball post.

### FIELD OF THE INVENTION

The present invention is in the field of trailer movers.

### DISCUSSION OF RELATED ART

When moving a trailer, typically motorized vehicles are used for towing trailers on roadways. After towing, a trailer needs to be stowed. Typically a boat or other machinery can be loaded on the trailer. The motor vehicle such as a truck or car is typically not very adept at fine adjustments. Accordingly, a variety of different trailer movers have been implemented in the prior art.

Most of these trailer movers have been pivotally connected to the trailer frame. For example, U.S. Pat. No. 7,621,356 by Quarberg issued Nov. 24, 2009, entitled Pallet Puller Tool provides a steerable trailer jack, the disclosure of which is incorporated herein by reference. Additionally, U.S. Pat. No. 6,619,671 to inventor Fine issued Sep. 16, 2003, entitled power wheel for a trailer tongue Jack, provides an improved Jack for a horizontally extending trailer tongue including a bracket attached to the trailer tongue, the disclosure of which is incorporated herein by reference. Inventor Fine also discusses a manually powered guidance in U.S. Pat. No. 6,739,601 issued May 24, 2004 entitled Trailer Tongue Jack Having Manually Powered Guidance, the disclosure of which is incorporated herein by reference.

### SUMMARY OF THE INVENTION

A trailer mover has a ball connection mechanism having a ball head mounted on a ball post and a ball collar. The ball collar has a raised position and a lowered position. The ball collar is mounted to the ball post so that the ball collar moves relative to the ball post when the ball collar is traveling between the raised position and the lowered position. The housing comprises a carriage body having a ball post retainer mounting surface on an upper portion of the carriage body. A ball post retainer is mounted to the ball post retainer mounting surface. The ball post retainer is configured to receive the ball post.

A transmission is mounted to the carriage body. The transmission is mounted within the housing in a portion of the housing called the transmission housing. A wheel is mounted to the wheel axle. The wheel axle is mounted to the carriage body. The transmission drives the wheel from a rotational input at the first axle. The ball head further includes a neck and shoulder. The neck is narrower than the head and shoulder.

The ball collar has a ball collar upper surface that is flat and annular. The ball collar is threaded to the ball post so that the ball collar travels between the raised position and the lowered position by rotation. The first axle has a first axle socket that receives a crank handle, wherein a rotation of the crank handle also turns the first axle. A transmission housing mounting surface is formed on the carriage body. The ball post retainer mounting surface is formed on the carriage body. The ball post retainer mounting surface is formed at an angle to the transmission housing mounting surface. A steering handle is mounted to the housing so that the steering handle is used for steering the trailer mover.

The transmission includes a first axle that drives a second axle via a first mechanical linkage. The second axle drives a third axle via a second mechanical linkage. The third axle drives a wheel axle via a fourth mechanical linkage which can be a chain or belt.

### BRIEF DESCRIPTION OF THE DRAWINGS

FIG. 1 is a side exploded view of the present invention.

FIG. 2 is a front view of the present invention.

FIG. 3 is a side view of the gear cascade of the present invention.

FIG. 4 is a front view of the gear cascade of the present invention.

FIG. 5 is a perspective view of the ball connection mechanism of the present invention.

FIG. 6 is an optional power tool attachment.

The following call out list of elements can be a useful guide in referencing the elements of the drawings.

### 10 Ball Connection Mechanism

### 11 Ball Hitch Head

### 12 Ball Collar

### 13 Ball Post

### 14 Ball Collar Socket

### 15 Ball Post Socket Opening

### 16 Neck

### 17 Shoulder

### 18 Shoulder Support

### 19 Adjustment Rod

### 20 Housing

### 21 Ball Post Retainer

### 22 Ball Post Retainer Opening

### 23 Ball Post Retainer Mounting Surface

### 24 Transmission Housing Mounting Surface

### 25 Transmission Housing

### 26 Steering Handle

### 27 Steering Handle Grip

### 28 Steering Handle Clip

### 29 Steering Handle Swivel

### 30 Carriage Body

### 31 Wheel Axle

### 32 Wheel

### 33 Carriage Body Slot

### 34 Steering Handle Latch

### 35 Crank Handle

### 36 Crank Handle Grip

### 40 Gear Cascade Mechanism

### 41 First Axle

### 42 Second Axle

### 43 Third Axle

### 51 First Chain

### 52 Second Chain

### 53 Third Chain

### 60 Sprocket Set

### 61 First Upper Sprocket

### 62 Second Upper Sprocket

### 63 Third Upper Sprocket

### 64 First Lower Sprocket

### 65 Second Lower Sprocket

### 66 Third Lower Sprocket

### 88 Ball Collar Upper Surface DETAILED DESCRIPTION OF THE PREFERRED EMBODIMENT

The present invention has a ball connection mechanism 10 that receives a trailer. The ball connection mechanism generally has two moving parts, namely a ball portion and a ball collar portion threadedly mounted to an exterior surface of the ball portion. The ball portion has a ball hitch head 11 is mounted to a ball post 13. The ball hitch head 11 further includes a neck 16 and a shoulder 17. The shoulder 17 is mounted on a shoulder support 18. The ball hitch head 11 narrows to the neck 16 and widens again to the shoulder 17. Preferably, the ball hitch head 11, the neck 16 and the shoulder 17 are formed integrally as a single piece of metal. The shoulder support 18 is rigidly connected to the ball post 13. The ball post 13 has a screw connection to the ball hitch head 11 so that the ball hitch head 11 can be interchanged for changing size for example. The ball post 13 is of a smaller diameter than the ball collar 12. The ball collar 12 is mounted to the ball post 13. The ball post 13 preferably has an external upper surface that is threaded which engages an internal threaded surface of the ball collar 12. The ball collar 12 threadedly turns relative to the ball post 13 by a ball collar socket 14. The ball collar socket can receive an adjustment rod 19. The adjustment rod 19 has a tip that engages the ball collar socket 14 so that the user can rotate the adjustment rod 19 manually for tightening the ball collar 12 via the adjustment rod 19 engagement with the ball collar socket 14. The ball collar 12 has an upper surface that is flat and annular shaped.

The ball post 13 and the ball post retainer 21 are formed as tubes having open ends that face each other. They also have openings that are used for connecting to each other. To allow a pin for example to fit through both of the openings. The pin could have a clip for retaining the pin in the openings. Preferably, a pair of openings face each other with a ball post socket opening 15 on a left side of the ball post 13 and also a second ball post socket opening 15 on the right side of the ball post 13. Similarly, the ball post retainer opening 22 can be formed on a left side of the ball post retainer 21, as well as a second ball post retainer opening being formed on a right side of the ball post retainer 21. The ball post 13 as a ball post socket opening 15 for connection to a ball post retainer opening 22. The ball post 13 makes a connection with the ball post retainer 21 by fitting inside of the ball post retainer 21. Alternatively, the ball post retainer 21 can fit within the ball post 13. Instead of a pin connection, other connections could be used.

The carriage body 30 supports the ball post retainer 21 because the ball post retainer 21 is formed on a ball post retainer mounting surface 23. The ball post retainer mounting surface 23 is horizontal when in use, and angled at an acute angle to the ground of approximately 20°-30° when not in use. The carriage body 30 is formed as a metal housing which is a part of the housing 20. The carriage body has a carriage body slot 33 that receives a wheel axle 31. The wheel axle 31 has a nut that engages the sidewall of the carriage body 30 to transmit load between the ball post retainer mounting surface 23 and the wheel axle 31. The wheel axle 31 has one or more wheels 32 mounted to it. The wheels rotate on the wheel axle 31 with the wheel axle 31 when the wheel axle 31 rotates.

The carriage body 30 also has a transmission housing mounting surface 24 formed on an upper surface of the carriage body 30. The transmission housing mounting surface 24 is adjacent to the ball post retainer mounting surface 23. The transmission housing mounting surface 24 is formed at an angle to the ball post retainer mounting surface 23 of approximately 20° to 30°. The transmission housing 25 is mounted to the transmission housing mounting surface 24 preferably by bolts. The transmission housing 25 has a pair of sidewalls, namely a left transmission housing sidewall and a right transmission housing sidewall. The transmission housing sidewalls are planar and can be cut from sheets of metal such as by plasma or laser cutting. Preferably, the metal panels forming the carriage body 30 and the transmission housing 25 are metallized or powder coated for resistance against environmental corrosion. The carriage body 30 can be integrally formed with the transmission housing 25 using metal bending techniques to make both housings from a single sheet of metal that can be welded at the seams.

The sprocket set 40 is located within the housing and provides a belt or chain system for actuating a gear cascade 60, which is a series of series connected gears.

The left and right transmission housing sidewalls have three openings that receive three transmission axles. A first axle 41 is mounted above a second axle 42, which is mounted above a third axle 43, which is mounted above the wheel axle 31. The three transmission axles are preferably arranged in a collinear configuration. The first axle 41, the second axle 42 and the third axle 43 can be secured to the left and right sides of the transmission housing 45 using bearings that are retained by circlips. The first axle 41, the second axle 42 and the third axle 43 preferably have the same diameter.

The first axle 41 has a first upper sprocket 61 mounted to the first axle 41. The first upper sprocket 61 engages a first chain 51. The first chain 51 is mounted between the first upper sprocket 61 and the first lower sprocket 64. A tensioner can be put on the chain as an option. The first lower sprocket 64 is mounted to the second axle 42. The second upper sprocket 62 is also mounted to the second axle 42. The first chain 51 transmits a rotation of the first axle 41 to the second axle 42 at a first mechanical advantage. The second upper sprocket 62 receives a second chain 52. The second chain 52 is also mounted to a second lower sprocket 65. The second lower sprocket 65 is mounted to a third axle 43. The third axle 43 therefore also has a pair of gears, namely the second lower sprocket 65 and the third lower sprocket 63. The third axle 43 receives a rotation from the second axle 42 where the second axle 42 has a mechanical advantage to turn the third axle 43. The third axle 43 then transmits the rotational force to the wheel axle 31. The wheel axle 31 has a third lower sprocket 66 that receives the third chain 53. The third chain is mounted between and transmit force from the third upper sprocket 63 to the third lower sprocket 66. The wheels 32 are rigidly connected to the wheel axle 31, so therefore they rotate when the first axle 41 or the second axle 42 is driven by the user.

The user turns the first axle 41 or the second axle 42 selectively by connecting the crank handle 35 to the first axle socket 44 on the first axle, or by connecting the crank handle 35 to the second axle socket 45 on the second axle 42. When the user desires a lower gear with a higher mechanical advantage, the user connects the crank handle 35 to the first axle socket 44 of the first axle 41. When the user desires a higher gear with a lower mechanical advantage, the user connects the crank handle 35 to the second axle socket 45 of the second axle 42. When the user switches between the lower gear and the higher gear, the user manually removes the crank handle 35 and replaces it on the various axle sockets.

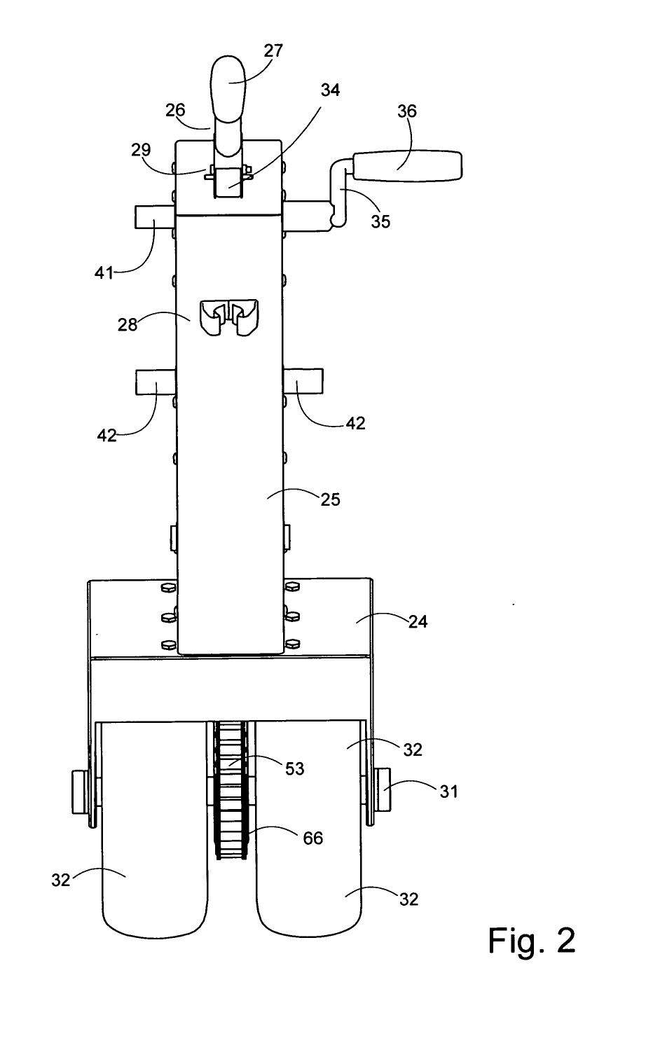

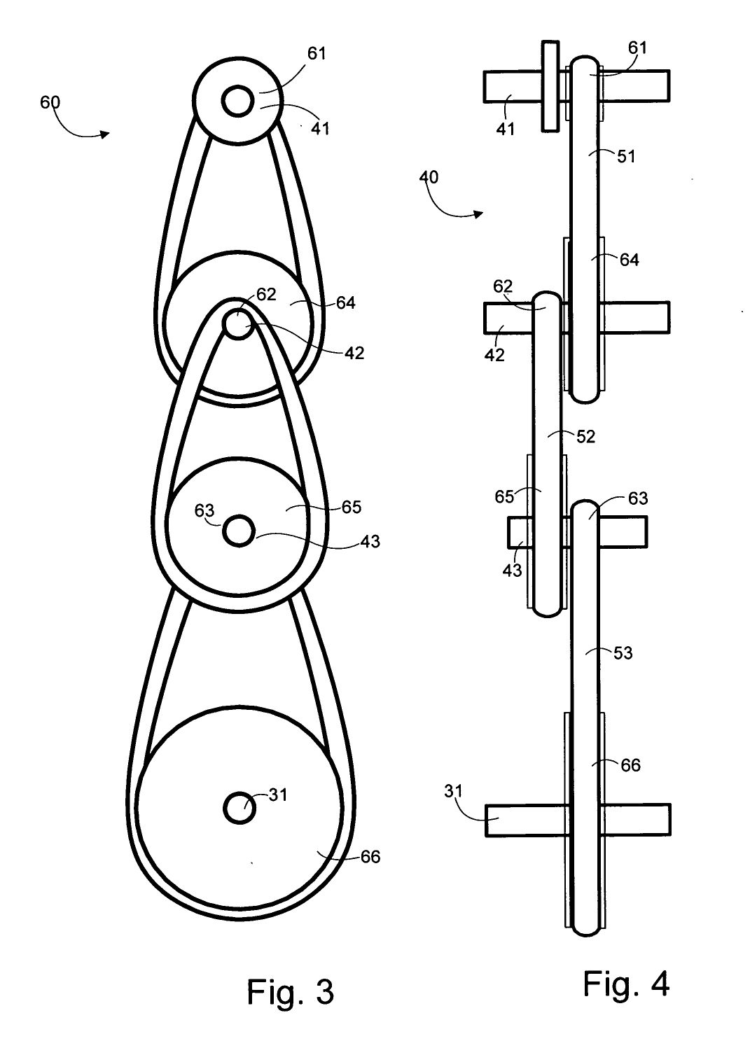

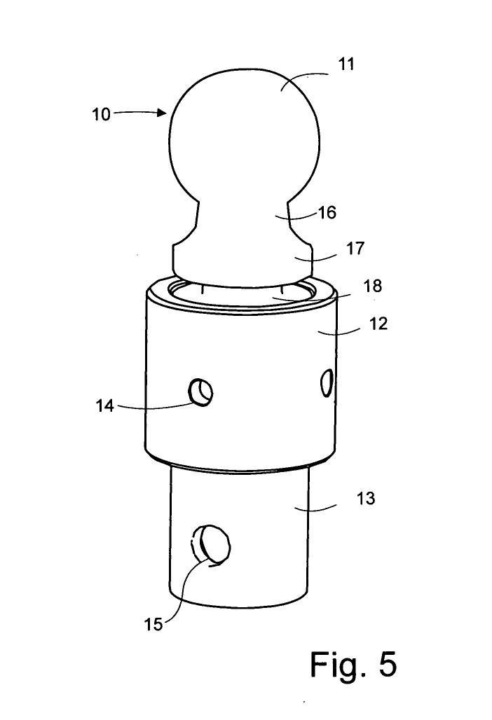

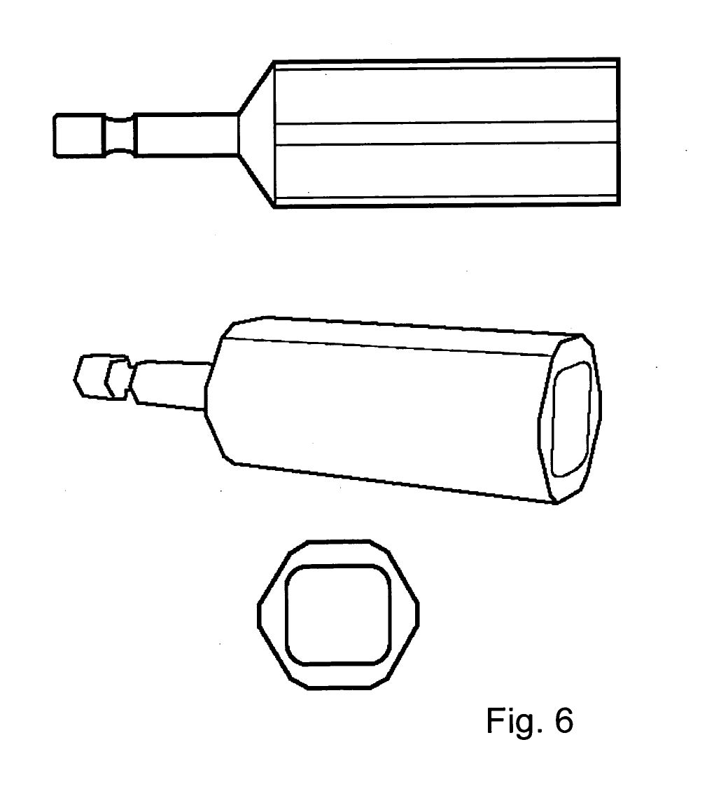

As seen in FIG. 2, the axle sockets can be formed on both sides of the axles. For example, the first axle 41 can have a right first axle socket 44 on a right end of the first axle. The first axle can also have a left first axle socket 44 on a left end of the first axle 41. The second axle 42 can have a left second axle socket 45 on a left end of the second axle 42 and the second axle 42 can have a right second axle socket 45 on the right end of the second axle 42. A user can switch the handle orientation for convenience, for handedness, or if the user needs to change sides because one of the user's arms becomes tired from manual cranking.

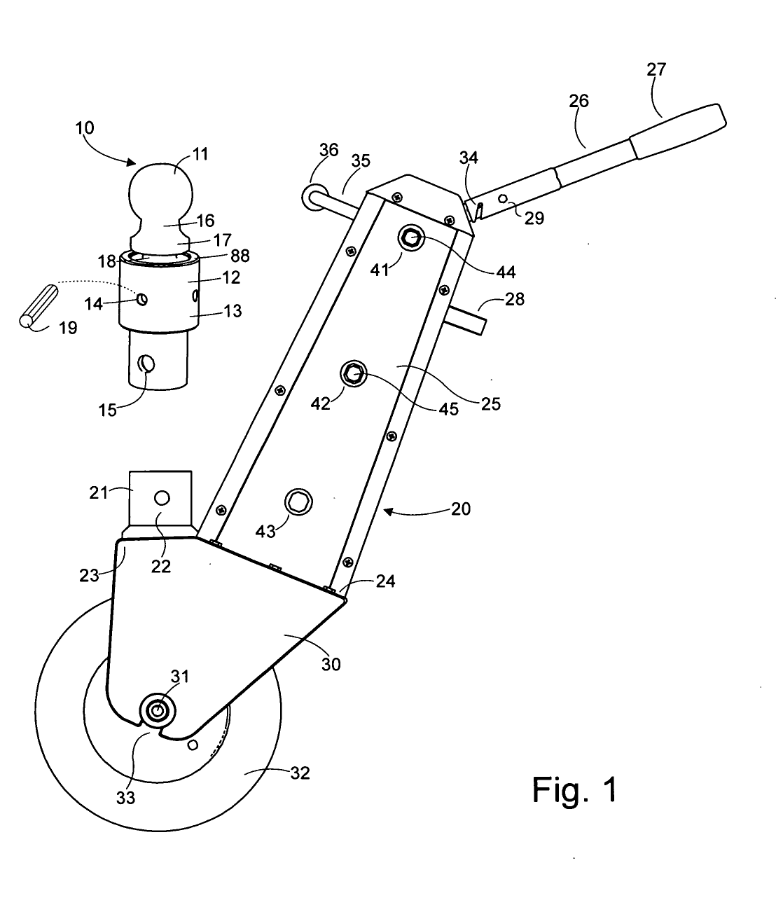

At an upper end of the transmission housing 25, a steering handle 26 is mounted to the transmission housing 25. The steering handle 26 can fold down when not in use so that the steering handle 26 engages the steering handle clip 28 which retains the steering handle 26 snugly between the left prong and the right prong of the steering handle clip 28. The steering handle clip 28 is mounted in a forward side face of the transmission housing 25. The forward side face of the transmission housing 25 is at a perpendicular angle to the left and the right side of the transmission housing 25. The transmission housing 25 is preferably made of metal panels that are bolted together. The steering handle 26 preferably includes a steering handle grip 27 for the comfort of the user. The steering handle 26 has a steering handle latch 34 which allows the user to latch and unlatch the steering handle. The user can unlatch the steering handle to raise it into a deployed position and then the handle can latch into the deployed position. The user can also unlatch the steering handle to stow it into a stowed position. As seen in FIG. 1, the steering handle latch can be formed by a slot cut out in the steering handle 26. A latching pin can control the latching and unlatching of the steering handle 26. A steering handle swivel 29 can be formed by a bolt or a rivet for allowing rotation of the steering handle 26 relative to the transmission housing 25.

The ball head 11 is typically received within a portion of the trailer. The trailer has a semi-spherical depression known as a coupler for receiving the ball head 11. The coupler also includes a releasable under jaw mechanism that captures the ball head 11 within the depression during towing. Typically, an under jar lever can release and engage the under jaw for selective capture of the ball head 11. The coupler has a lower edge that may have a flange. The user rotates the ball collar so that a flat surface of the ball collar upper surface engages the flange of the coupler. The user then rotates the crank while steering the steering handle 26.

A variety of different changes to the present invention can be made while reserving the spirit of the invention, such as adding additional mechanisms to the mechanical linkages between the axles such as additional axles, gears, sprockets or chains. For example, as shown in FIG. 6, an optional power tool attachment is provided for attachment to a power tool such as a powered mechanical drill, or mechanical screwdriver having a portable battery. The optional power tool attachment is formed as a bit and has a socket for engaging the trailer mover, and a connection for the power tool.

1-15. (canceled)

16. A trailer mover comprising:
a ball connection mechanism having a ball head mounted on a ball post and a ball collar, wherein the ball collar has a raised position and a lowered position; wherein the ball collar is mounted to the ball post so that the ball collar moves relative to the ball post when the ball collar is traveling between the raised position and the lowered position, wherein the ball head further includes a neck and shoulder, wherein the neck is narrower than the head and shoulder, wherein the ball collar has a ball collar upper surface that is flat and annular, wherein the ball collar is threaded to the ball post so that the ball collar travels between the raised position and the lowered position by rotation;
a housing, wherein the housing comprises a carriage body having a ball post retainer mounting surface on an upper portion of the carriage body, wherein a ball post retainer is mounted to the ball post retainer mounting surface, wherein the ball post retainer is configured to receive the ball post;
a transmission mounted to the carriage body, wherein the transmission is mounted within the housing in a portion of the housing called a transmission housing;
a wheel mounted to a wheel axle, wherein the wheel axle is mounted to the carriage body, wherein the transmission drives the wheel from a rotational input at a first axle, wherein the transmission includes a first axle that drives a second axle via a first mechanical linkage, wherein the second axle drives a third axle via a second mechanical linkage, wherein the third axle drives the wheel axle via a third mechanical linkage, wherein the wheel has a pair of tires mounted to it, wherein the third mechanical linkage passes between the pair of tires, wherein the first axle has a first axle socket that receives a crank handle, wherein a rotation of the crank handle also turns the first axle;
a transmission housing mounting surface formed on the carriage body, wherein the ball post retainer mounting surface is formed at an angle to the transmission housing mounting surface; and
a steering handle mounted to the housing, whereby the steering handle is used for steering the trailer mover.

17. The trailer mover of claim 16, wherein the ball post and the ball post retainer are formed as tubes having open ends that face each other.

18. The trailer mover of claim 17, wherein the ball post has a ball post socket opening, and wherein the ball post retainer has a ball post retainer opening, wherein the ball post socket opening aligns to the ball post retainer opening for providing a detachable connection between the ball post and the ball post retainer.
